(19) United States
(12) Patent Application Publication
(10) Pub. No.: US 2025/0187756 A1
(43) Pub. Date: Jun. 12, 2025

(54) DEVICES, SYSTEMS, AND METHODS FOR MANUFACTURING, ALTERING, AND CONVERTING A FUSELAGE SUITABLE FOR A FREIGHTER AIRCRAFT

(71) Applicant: IPR Conversions (Switzerland) LTD, Zug (CH)

(72) Inventor: Sébastien COURNET, Saint Lys (FR)

(73) Assignee: IPR Conversions (Switzerland) LTD, Zug (CH)

(21) Appl. No.: 18/842,322

(22) PCT Filed: Feb. 28, 2022
(86) PCT No.: PCT/EP2022/055006

§ 371 Date: Aug. 28, 2024

(51) Int. Cl. B64F 5/10; B64C 1/06

(52) U.S. Cl. CPC B64F 5/10; B64C 1/068

(57) ABSTRACT

An aircraft that is certifiable for freighter transport is disclosed herein. The aircraft can include a hybrid fuselage including a plurality of modular sections, wherein the plurality of modular sections includes a first section, a second section, and an intermediate section, and wherein the intermediate section is disposed intermediate the first section and the second section. The aircraft can further include a plurality of systems traversing the plurality of modular sections and a plurality of structural components configured to mechanically couple the intermediate section to the first section and the second section of the plurality of modular sections. The first section and the second section are configured for use with a fuselage of a passenger aircraft, and wherein the intermediate section is configured for use with a fuselage of a freighter aircraft.

### TECHNICAL FIELD

The present disclosure relates generally to aircrafts and aircraft manufacturing. More particularly, the present disclosure relates to devices, systems and methods for converting a passenger aircraft fuselage into a cargo aircraft fuselage.

### BACKGROUND

Although passenger-to-freighter conversions have historically served as a way to extend the economic life of an aircraft, the need to pursue a fleet of adaptable aircraft is ever growing. As more people work from home and meet virtually, and as e-commerce continues to increase in popularity, more companies (e.g., airlines) may be motivated to convert at least a portion of a their passenger fleet into freighter suitable aircraft. However, the fuselage of an aircraft must be particularly designed and certified for its intended use, which can complicate the conversion. For example, passenger fuselages are typically designed to prioritize passenger and crew comfort, with a limited interior volume (e.g., the hold) reserved for cargo. Contrarily, a freighter is predominantly used to transport goods and thus, its fuselage is typically designed to prioritize ease of access and payload (e.g. cargo, inventory, mail, equipment) security.

Access, specifically, is essential for a freighter, as the size and location of the fuselage cargo door can severely limit the efficiency with which the crew can load and unload the fuselage. The door of a passenger aircraft would preclude an operator from loading pallets into the fuselage, potentially limiting them to loading a payload in piecemeal fashion. Conventional processes for passenger-to-freighter conversion rely on cutting holes Although it is possible to convert the fuselage of a passenger aircraft to a fuselage for use as a freighter, the turnaround time can render such conversions impractical.

Additionally, aircrafts must be approved, certified and/or validated for an intended use by the appropriate regulatory authority. For example, the European Aviation Safety Agency (EASA), the Federal Aviation Administration (FAA), Transport Canada (TCCA) and/or the Civil Aviation Administration of China (CAAC) each grants its own form of type certification. Type certifications signify the airworthiness of a particular category of aircraft, according to its manufacture, type, and/or design. Generally, a type certificate confirms that the aircraft is compliant with applicable requirements for its intended use, as established by the national and/or international aviation law. Accordingly, there is a need for new devices, systems, and methods for manufacturing and/or converting a fuselage suitable for a freighter aircraft.

### SUMMARY

In various aspects, a method of manufacturing and/or converting an aircraft that is certifiable for freighter transport is disclosed. The method can include leveling a first fuselage including a plurality of modular sections, wherein the plurality of modular sections includes a first section, a second section, and an intermediate section, wherein the intermediate section is disposed intermediate the first section and the second section, and wherein leveling the first fuselage offsets loads imposed on the first section, the second section, and the intermediate section; installing a support under the intermediate section of the plurality of modular sections; decoupling a plurality of systems of the intermediate section from a plurality of corresponding systems of the first section and a plurality of corresponding systems of the second section; decoupling a plurality of structural components of the intermediate section from a plurality of corresponding structural components of the first section and a plurality of corresponding structural components of the second section; repositioning the intermediate section such that the intermediate section is no longer disposed intermediate the first section and the second section; positioning a replacement section of a second fuselage such that the replacement section is disposed intermediate the first section and the second section; coupling a plurality of structural components of the replacement section to the plurality of corresponding structural components of the first section and the plurality of corresponding structural components of the second section; coupling a plurality of systems of the replacement section to the plurality of corresponding systems of the first section and the plurality of corresponding systems of the second section; and leveling the replacement section, the first section, and the second section such that loads are imposed on the first section, the second section, and the replacement section. intermediate section and the replacement section.

In various aspects, an aircraft that is certifiable for freighter transport is disclosed. The aircraft can include: a hybrid fuselage including a plurality of modular sections, wherein the plurality of modular sections includes a first section, a second section, and an intermediate section, wherein the intermediate section is disposed intermediate the first section and the second section; a plurality of systems traversing the plurality of modular sections, wherein each system of the plurality comprises portions positioned within each section of the plurality and interfaces configured to systematically couple the portions positioned within each section of the plurality; and a plurality of structural components configured to mechanically couple the intermediate section to the first section and the second section of the plurality of modular sections, wherein the first section and the second section are configured for use with a first fuselage, and wherein the intermediate section is configured for use with a second fuselage.

In various aspects, a system for manufacturing and/or converting an aircraft that is certifiable for freighter transport is disclosed. The system can include: a first section, a second section, and an intermediate section configured for use with a first fuselage; a replacement section configured for use with a second fuselage, wherein the intermediate section and the replacement section are configured to be disposed intermediate the first section and the second section, wherein the intermediate section and the replacement section are further configured to be mechanically coupled to the first section and the second section via a plurality of structural components, and wherein each of the first section, the second section, the intermediate section, and the replacement section include a portion of a plurality of systems configured to be systematically coupled via a plurality of interfaces; and a support configured to be installed underneath and transport the intermediate section and the replacement section, wherein, when installed underneath the intermediate section and the replacement section, the support is configured to offset loads imposed on the

These, and other objects, features, and characteristics of the present invention, as well as the methods of operation, and functions of the related elements of structure, and the combination of parts, and economies of manufacture, will become more apparent upon consideration of the following description, and the appended claims with reference to the accompanying drawings, all of which form a part of this specification, wherein like reference numerals designate corresponding parts in the various figures. It is to be expressly understood, however, that the drawings are for the purpose of illustration, and description only, and are not intended as a definition of the limits of the invention.

### BRIEF DESCRIPTION OF THE DRAWINGS

Various features of the aspects described herein are set forth with particularity in the appended claims. The various aspects, however, both as to organization, and methods of operation, together with advantages thereof, may be understood in accordance with the following description taken in conjunction with the accompanying drawings as follows:

FIG. 1 illustrates FIG a mutli-sectioned aircraft fuselage, in accordance with at least one non-limiting aspect of the present disclosure;

FIG. 2 illustrates a method of manufacturing and/or converting a fuselage suitable for a freighter aircraft, in accordance with at least one non-limiting aspect of the present disclosure;

FIG. 3 illustrates a support configured to offset loads imposed on one or more sections of the aircraft fuselage of FIG. 1 in accordance with at least one non-limiting aspect of the present disclosure;

FIG. 4 illustrates a hydraulic system of the aircraft fuselage of FIG. 1, in accordance with at least one non-limiting aspect of the present disclosure;

FIG. 5 illustrates an environmental control system of the aircraft fuselage of FIG. 1, in accordance with at least one non-limiting aspect of the present disclosure;

FIG. 6 illustrates an electrical system of the aircraft fuselage of FIG. 1, in accordance with at least one non-limiting aspect of the present disclosure;

FIG. 7 illustrates a structural system of the aircraft fuselage of FIG. 1, in accordance with at least one non-limiting aspect of the present disclosure;

FIGS. 8A-C illustrate several mechanical alignments and tolerances between sections of the aircraft fuselage of FIG. 1, in accordance with at least one non-limiting aspect of the present disclosure;

FIG. 9 illustrates a new aircraft fuselage that has been converted using the method of FIG. 2, in accordance with at least one non-limiting aspect of the present disclosure;

FIGS. 10A-E illustrate several coupling devices configured to align neutral axes of fuselage sections and resolve tolerance mismatches, in accordance with at least one non-limiting aspect of the present disclosure;

FIGS. 11A and 11B illustrate a coupling step of the method of FIG. 2 that utilizes the coupling device of FIG. 10E, in accordance with at least one non-limiting aspect of the present disclosure;

FIGS. 12A-C illustrate another coupling device configured to align neutral axes of fuselage sections and resolve tolerance mismatches, in accordance with at least one non-limiting aspect of the present disclosure;

FIGS. 13A-C illustrate another coupling device configured to align neutral axes of fuselage sections and resolve tolerance mismatches, in accordance with at least one non-limiting aspect of the present disclosure;

FIGS. 14A-C illustrate another coupling device configured to align neutral axes of fuselage sections and resolve tolerance mismatches, in accordance with at least one non-limiting aspect of the present disclosure; and

FIGS. 15A and 15B illustrate a coupling step of the method of FIG. 2 that utilizes the coupling device of FIG. 14A-C, in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure, and illustrated in the accompanying drawings. Well-known operations, components, and elements have not been described in detail so as not to obscure the aspects described in the specification. The reader will understand that the aspects described, and illustrated herein are non-limiting aspects, and thus it can be appreciated that the specific structural, and functional details disclosed herein may be representative, and illustrative. Variations, and changes thereto may be made without departing from the scope of the claims. Furthermore, it is to be understood that such terms as “forward”, “rearward”, “left”, “right”, “upwardly”, “downwardly”, and the like are words of convenience, and are not to be construed as limiting terms.

In the following description, like reference characters designate like or corresponding parts throughout the several views of the drawings. Also in the following description, it is to be understood that such terms as “forward”, “rearward”, “left”, “right”, “upwardly”, “downwardly”, and the like are words of convenience, and are not to be construed as limiting terms.

Before explaining various aspects of the systems, and methods disclosed herein in detail, it should be noted that the illustrative aspects are not limited in application or use to the details of disclosed in the accompanying drawings, and description. It shall be appreciated that the illustrative aspects may be implemented or incorporated in other aspects, variations, and modifications, and may be practiced or carried out in various ways. Further, unless otherwise indicated, the terms, and expressions employed herein have been chosen for the purpose of describing the illustrative aspects for the convenience of the reader, and are not for the purpose of limitation thereof. For example, it shall be appreciated that any reference to a specific manufacturer, product number, process, certifications, or platform disclosed herein is merely intended to illustrate several of the many aspects of the present disclosure. This includes any, and all references to trademarks. Accordingly, it shall be appreciated that the devices, systems, and methods disclosed herein can be implemented to enhance the assembly of any aircraft with any equivalent parts or processes disclosed herein. The specifics may be determined in accordance with any intended use, and/or user preference.

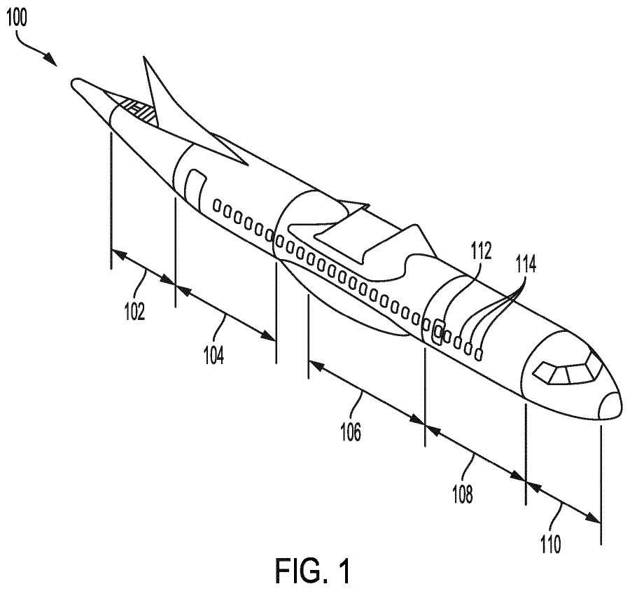

As previously described, there is a need for new devices, systems, and methods for manufacturing, and/or converting a fuselage suitable for a freighter aircraft. Mitigating the dimensional and tolerance mismatches between the fuselage of a passenger aircraft (e.g., that of a 72-500) and the fuselage of a converted or to be converted freighter aircraft (e.g., that of an either a 72-212A and/or 72-600) can be problematic and has traditionally precluded successful conversion and thus, certification of the resulting aircraft for freight. For example, integrating a cargo section—such as a fuselage Section 13 of a freighter aircraft—between a nose section and a body section, such as a Section 11 and Section 15 of a passenger aircraft, respectively—will result in two problems. First, the nose and body sections of a passenger aircraft have high tolerances, whereas the cargo section of a freighter aircraft requires a relatively high degree of dimensional precision. Thus, converting the section of a passenger aircraft that corresponds to the cargo section of a freighter aircraft would require the installation of high-precision parts (e.g., doors, frames, stringers, and primary structures, etc.) into a fuselage that has already been drilled with holes of an unacceptably high tolerance. For example, FIG. 1 depicts a mutli-sectioned aircraft fuselage 100 according to at least one non-limiting aspect of the present disclosure. According to the non-limiting aspect of FIG. 1, the aircraft fuselage 100 can include a plurality of sections 102, 104, 106, 108, 110, wherein each section 102, 104, 106, 108, 110 of the plurality is specifically configured to be mechanically coupled to an adjacent section 102, 104, 106, 108, 110 of the plurality. Each section 102, 104, 106, 108, 110 of the plurality can be manufactured separately and thus, can include interfaces or “junction points” by which the sections are mechanically and systematically coupled. Additionally, according to the non-limiting aspect of FIG. 1, the plurality can include five sections 102, 104, 106, 108, 110. However, according to other non-limiting aspects, the aircraft 100 fuselage can be segmented into two or more sections, depending on user preference and/or intended application.

Notably, the aircraft fuselage 100 of FIG. 1 is configured for passenger travel, as is evident from the door 112, which is configured for passenger ingress and egress, interposed in section 108. The aircraft fuselage 100 of FIG. 1 further includes a plurality of windows 114 defined within each section 102, 104, 106, 108, 110 of the plurality, including section 108, which further indicates that the aircraft fuselage 100 is designed for passenger travel. In other words, the aircraft fuselage 100 of FIG. 1 may be configured for passenger transport, such as the 72-500. Accordingly, the aircraft fuselage 100 of FIG. 1 was produced with high tolerances and thus, absent the systems, devices, and methods disclosed herein, would be otherwise incompatible with high-precision parts required for a passenger-to-freighter conversion. Dimensional mismatches and misalignments would preclude the removal of section 108 and subsequent installation of a corresponding section of a freighter aircraft, such as the either a 72-212A and/or 72-600, for example.

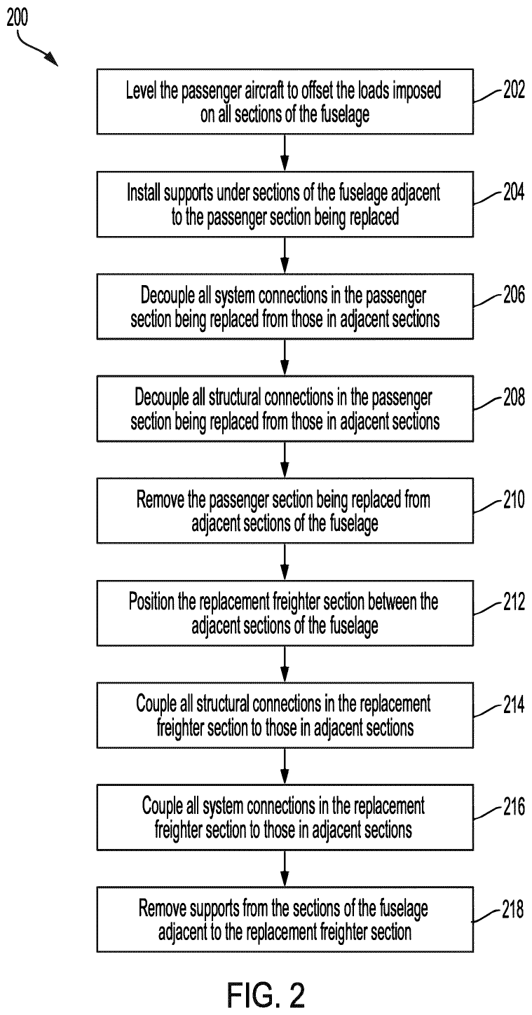

Referring now to FIG. 2, a method 200 of manufacturing and/or converting a fuselage suitable for a freighter aircraft is depicted in accordance with at least one non-limiting aspect of the present disclosure. For example, the method 200 of FIG. 2 can be employed to convert a high-tolerance, passenger aircraft fuselage, such as the aircraft fuselage 100 of FIG. 1, into a aircraft fuselage suitable for freighter transport. For example, although the aircraft fuselage 100 of FIG. 1 has high-tolerance sections 102, 104, 106, 108, 110, the method 200 of FIG. 2 can enable the integration of a high-precision freighter section, in spite of the known dimensional and tolerance mismatches.

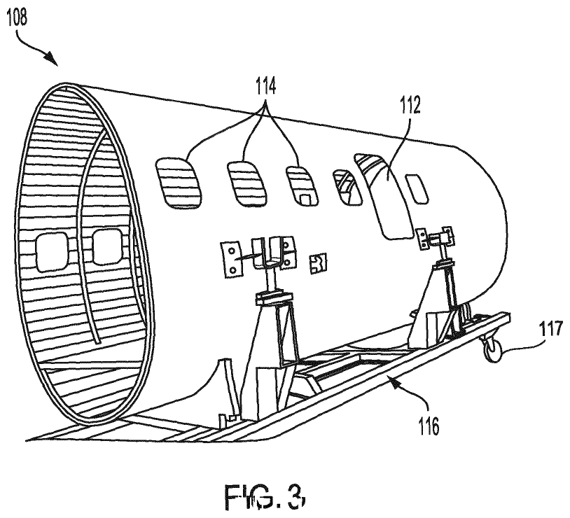

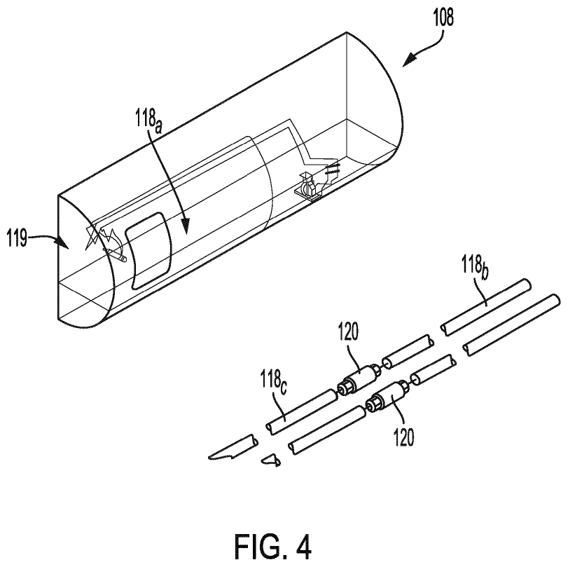

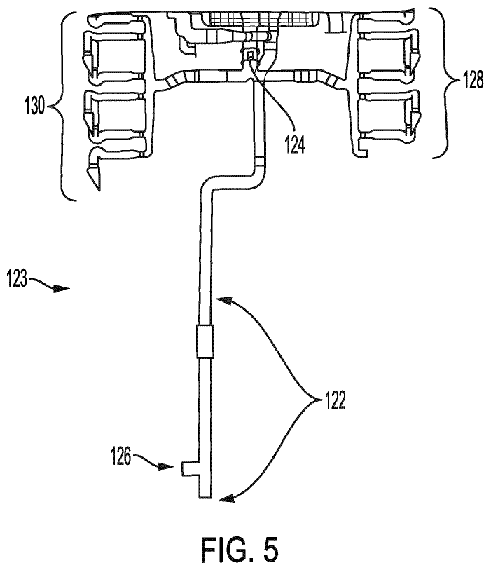

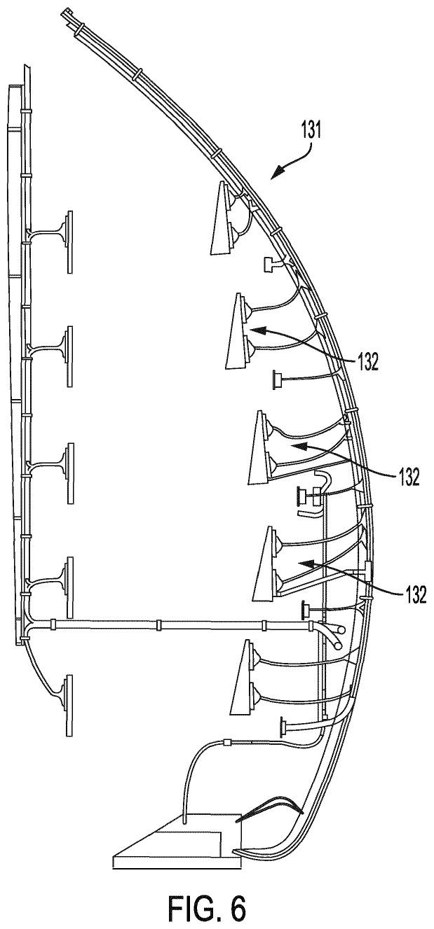

According to the non-limiting aspect of FIG. 2, the method 200 can include leveling 202 a passenger aircraft fuselage, such as the aircraft fuselage 100 of FIG. 1, such that any loads imposed on each of its sections are offset. Once the loads have been offset, the method 200 can further include installing 204 supports under the sections of the fuselage that are adjacent to the passenger section that is going to be replaced. For example, a non-limiting example of one such support 116 is depicted and described in further detail in reference to FIG. 3. Having offset the loads from the fuselage, an intermediate step of determining the real neutral axis of the aircraft fuselage (e.g., fuselage 100 of FIG. 1) may be performed. The actual neutral axis may be different than what was theoretically conceived, due to tolerance issues and mismatching. Having installed the supports, the method 200 can further include decoupling 206 all systems in the passenger section being replaced from corresponding system connections in the adjacent sections. The systems that require decoupling can include any mechanical and/or electrical system necessary for the aircraft to function as intended and/or designed. For example, the systems can include a hydraulic system, such as the hydraulic system 119 depicted in FIG. 4, an air conditioning system, such as the environmental control system 123 depicted in FIG. 5, and/or an electrical system, such as the electrical system 131 depicted in FIG. 6. Of course, these are non-limiting examples exclusively presented for illustrative purposes, and the method 200 can further include decoupling 206 any other systems that traverse multiple sections of the aircraft, including a flight control system, a landing gear system, an engine bleed air system, an avionics, alternate environmental control systems, and/or fuel systems, amongst others.

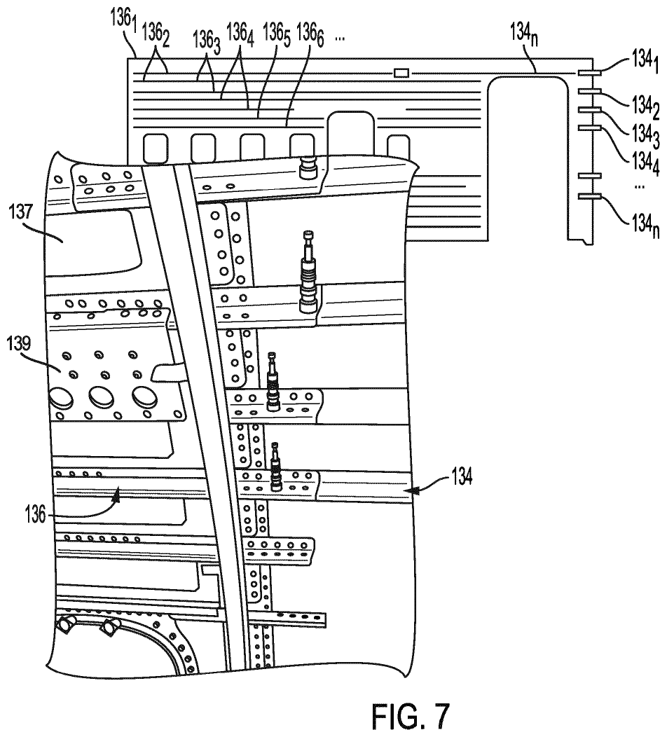

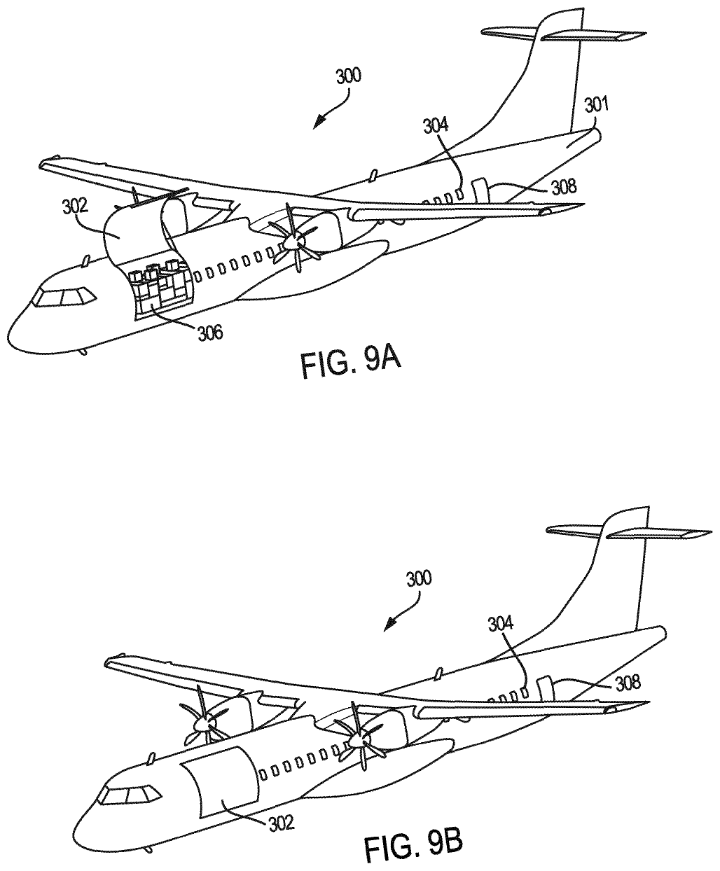

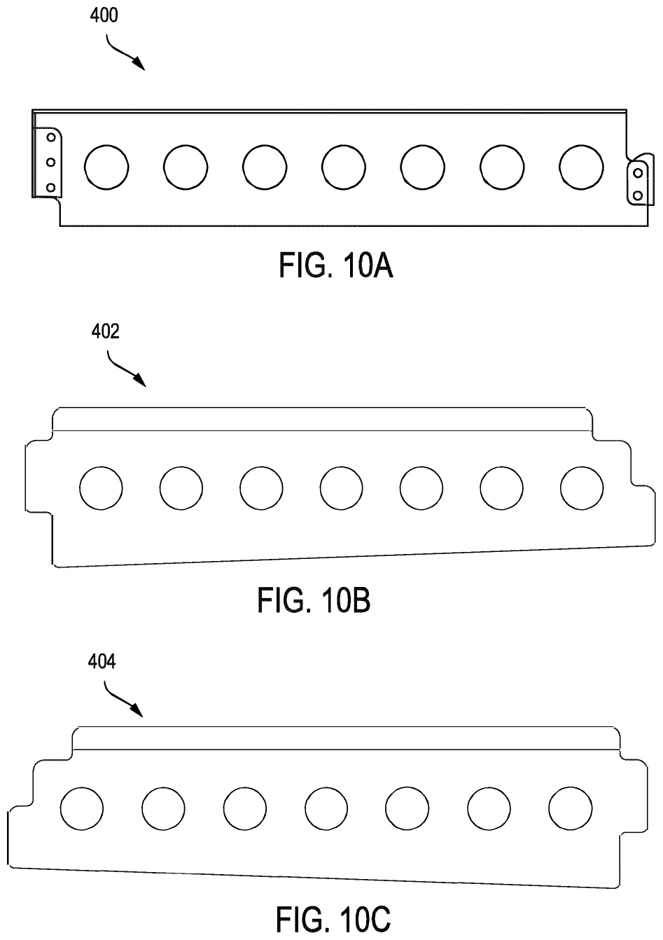

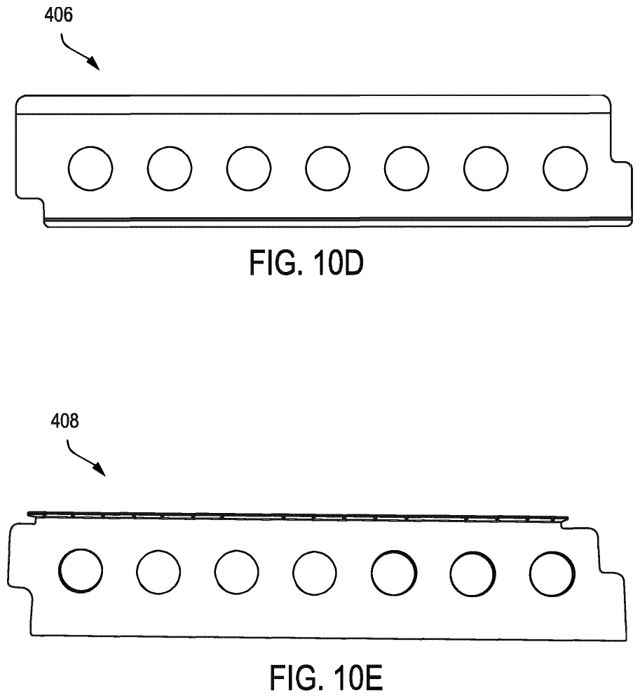

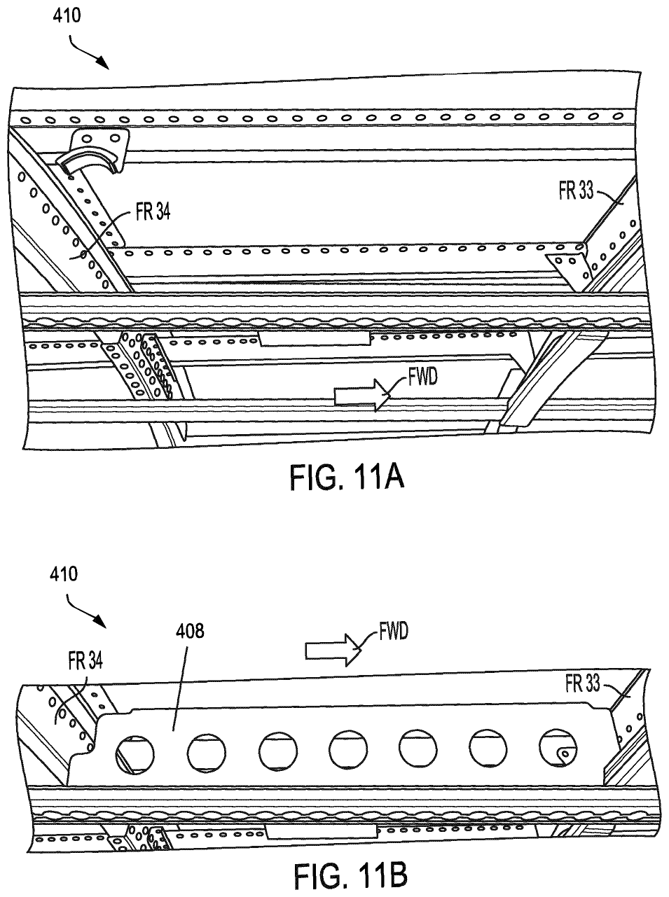

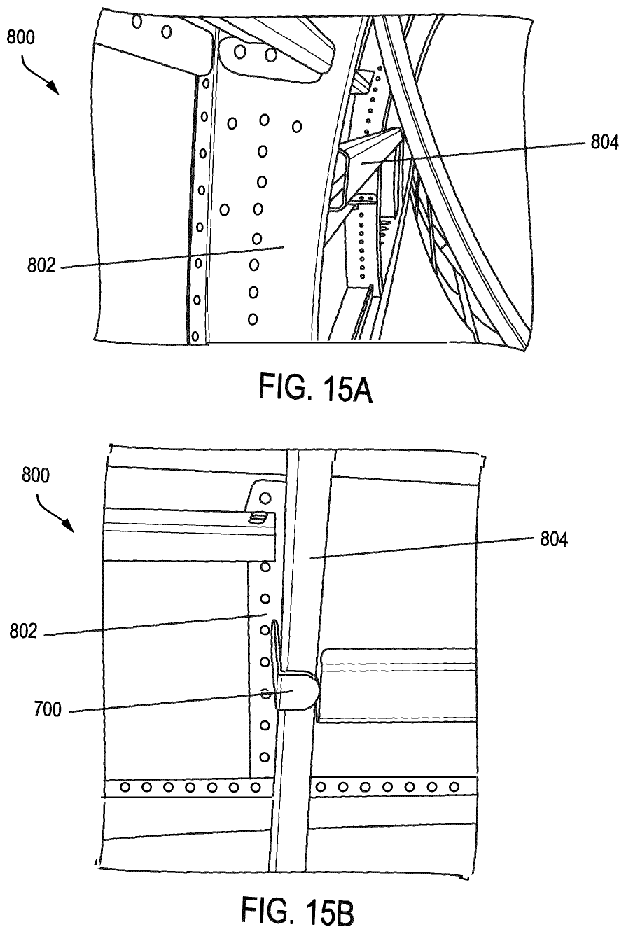

In further reference to FIG. 2, the method 200 can further include decoupling 208 all of the structural connections in the passenger section of the fuselage that is being replaced from those interfaces, or junction points, of the adjacent sections. In other words, all of the mechanical components that keep the passenger section of the fuselage that is being replaced attached to the adjacent sections must be removed. Such components can include any sheet metal overlays, skin doublers, and/or stringer straps, amongst others, as depicted in the structural system 135 of FIG. 7. Once the passenger section of the fuselage that is being replaced is no longer attached to the adjacent sections, the method 200 can include removing 210 the passenger section from the adjacent sections of the fuselage. The replacement freighter section can then be positioned 212 between the adjacent sections, and the method 200 can be reversed. However, in positioning the replacement freighter section, the actual neutral axis of the other sections of the fuselage (e.g., sections 106, 110) must be aligned with the actual neutral axis of the replacement section (e.g., replacing section 108). In other words, the method 200 can further include coupling 214 all of the structural connections in the replacement freighter section to those in adjacent sections, coupling 216 all of the system connections in the replacement freighter section to those in the adjacent sections, and removing 218 the supports from the sections of the fuselage adjacent to the replacement freighter section. Accordingly, the method 200 can result in an aircraft fuselage similar to that depicted in FIG. 9. However, based on the inevitable alignment issues related to the actual neutral axes of the sections, as addressed during the positioning 212 step, certain tooling may be required to achieve the proper coupling 214. Custom tools, such as those depicted in FIGS. 10A-10E, FIGS. 12A-12C, FIGS. 13A-13C, and FIGS. 14A-14C can be implemented to address any disparity between actual neutral axes of the sections during the coupling 214 step of the method 200. As such, illustrations of the coupling 214 step, according to at least some non-limiting aspects of the present disclosure, are depicted in FIGS. 11A and 11B and FIGS. 15A and 15B.

Referring now to FIG. 3, a support 116 configured to offset loads imposed on one or more sections of the aircraft fuselage 100 of FIG. 1 is depicted in accordance with at least one non-limiting aspect of the present disclosure. According to the non-limiting aspect of FIG. 3, the support 116 can be utilized to offset loads imposed on section 108 of the aircraft fuselage 100 of FIG. 1, a passenger section that can be replaced with a freighter section via the method 200 of FIG. 2. However, as previously discussed, the support 116 can be alternately configured to offset loads imposed on any section 102, 104, 106, 108, 110 (FIG. 1) of the aircraft fuselage 100 (FIG. 1), including sections 106, 110 (FIG. 1) that are adjacent to the passenger section that is being replaced 108. According to the non-limiting aspect of FIG. 3, the support 116 can further include one or more castors 117, or any equivalent means of transporting the support 116 with the section 108 installed on it, from one location to another. As such, the support 116 can be used to offset loads imposed on the sections 102, 104, 106, 108, 110 (FIG. 1) of the aircraft fuselage 100 (FIG. 1), independently support each section 102, 104, 106, 108, 110 (FIG. 1), and facilitate the relocation of sections 102, 104, 106, 108, 110 (FIG. 1) relative to one another. In other words, the support 116 enables the modular re-configuration of the aircraft fuselage 100 of FIG. 1.

Referring now to FIG. 4, a hydraulic system 119 of the aircraft fuselage 100 of FIG. 1 is depicted in accordance with at least one non-limiting aspect of the present disclosure. According to the non-limiting aspect of FIG. 4, the hydraulic system 119 can include a plurality of hydraulic pipes 118_{a-c} coupled together with a plurality of fittings (e.g., those manufactured by Permaswage, Gates, Eaton, Parker, etc.) configured to couple at least two of the plurality of hydraulic pipes 118_{a-c} of the plurality together such that a hydraulic fluid can be transported throughout the hydraulic system 119 of the aircraft fuselage 100 (FIG. 1). The hydraulic system 119—and more specifically, the plurality of hydraulic pipes 118_{a-c}—can be configured to traverse one or more sections 102, 104, 106, 108, 110 (FIG. 1) of the aircraft fuselage 100. The fittings 120 can enable a user to decouple a portion of the hydraulic system 119 in the passenger section 108 being replaced from corresponding hydraulic system 119 components in sections 106, 110 (FIG. 1) that are adjacent to the passenger section 108 being replaced, in accordance with the method 200 of FIG. 2. Likewise, the fittings 120 can enable a user to re-couple a portion of the hydraulic system 119 in a replacement freighter section (not shown) to corresponding hydraulic system 119 components in sections 106, 110 (FIG. 1) that are adjacent to the passenger section 108 being replaced, in accordance with the method 200 of FIG. 2.

Referring now to FIG. 5, an environmental control system 123 of the aircraft fuselage 100 of FIG. 1 is depicted in accordance with at least one non-limiting aspect of the present disclosure. The environmental control system 123 can include an air conditioning subsystem, a heating subsystem, a humidity subsystem, and/or a pressurizing subsystem, amongst other subsystems configured to control the environment within and/or around the aircraft fuselage 100 of FIG. 1. For example, according to the non-limiting aspect of FIG. 4, the environmental control system 123 includes an air conditioning subsystem including a system of pipes connected via one or more couplers 122, one or more shut-off valves 124, one or more vents 126, a left-hand cargo outlet 128, and a right-hand cargo outlet 130. The environmental control system 123—and more specifically, the system of pipes—can be configured to traverse one or more sections 102, 104, 106, 108, 110 (FIG. 1) of the aircraft fuselage 100 (FIG. 1).

Still referring to FIG. 5, one or more shut-off valves 124 positioned within sections 106, 110 (FIG. 1) that are adjacent to the passenger section 108 (FIG. 1) being replaced can be used to isolate a portion of the environmental control system 123 positioned within the section 108 (FIG. 1) being replaced. Accordingly, the couplers 122 can enable a user to decouple a portion of the environmental control system 123 in the passenger section 108 (FIG. 1) being replaced from corresponding environmental control system 123 components in sections 106, 110 (FIG. 1) that are adjacent to the passenger section 108 being replaced, in accordance with the method 200 of FIG. 2. Likewise, the couplers 122 can enable a user to re-couple a portion of the environmental control system 123 in a replacement freighter section (not shown) to corresponding environmental control system 123 components in sections 106, 110 (FIG. 1) that are adjacent to the passenger section 108 (FIG. 1) being replaced, in accordance with the method 200 of FIG. 2.

Referring now to FIG. 6, an electrical system 131 of the aircraft fuselage 100 of FIG. 1 is depicted in accordance with at least one non-limiting aspect of the present disclosure. According to the non-limiting aspect of FIG. 6, the electrical system 131 can include a plurality of harnesses 133 terminated in, and configured to be electrically coupled via, a plurality of electrical connectors 132. The electrical system 131—and more specifically, the plurality of harnesses 133—can be configured to traverse one or more sections 102, 104, 106, 108, 110 (FIG. 1) of the aircraft fuselage 100 (FIG. 1). Accordingly, the electrical connectors 132 can enable a user to decouple a portion of the electrical system 131 in the passenger section 108 (FIG. 1) being replaced from corresponding electrical system 131 components in sections 106, 110 (FIG. 1) that are adjacent to the passenger section 108 being replaced, in accordance with the method 200 of FIG. 2. Likewise, the electrical connectors 132 can enable a user to re-couple a portion of the electrical system 131 in a replacement freighter section (not shown) to corresponding electrical system 131 components in sections 106, 110 (FIG. 1) that are adjacent to the passenger section 108 (FIG. 1) being replaced, in accordance with the method 200 of FIG. 2.

Referring now to FIG. 7, a structural system 135 of the aircraft fuselage 100 of FIG. 1 is depicted in accordance with at least one non-limiting aspect of the present disclosure. According to the non-limiting aspect of FIG. 7, the structural system 135 can include various components, such as sheet metal overlays 137, skin doublers 139, and/or mating stringer straps 134, 136, amongst others. The sheet metal overlays 137, skin doublers 139, and mating stringer straps 134, 136 are configured to mechanically couple the passenger section 108 (FIG. 1) being replaced to other sections 106, 110 (FIG. 1) that are adjacent to the passenger section 108 being replaced. In other words, the sheet metal overlays 137, skin doublers 139, and mating stringer straps 134, 136 are configured to transmit and disperse mechanical loads across the aircraft fuselage 100 (FIG. 1), including the passenger section 108 (FIG. 1) being replaced and its adjacent sections 106, 110 (FIG. 1).

For example, according to the non-limiting aspect of FIG. 7, the passenger section 108 (FIG. 1) being replaced can include a plurality of stringers 136ₗ₋ₙ that traverse an axis defined by the aircraft fuselage 100 (FIG. 1), each of which terminate in one of a plurality of mechanical connectors 134ₗ₋ₙ. Each mechanical connector 134ₗ₋ₙ of the plurality is configured to mechanically couple the each of the plurality of stringers 136ₗ₋ₙ to a corresponding stringer (not shown) on a section section 106, 110 (FIG. 1) adjacent the section 108 (FIG. 1) being replaced. Once the sheet metal overlays 137, skin doublers 139, and mating stringer straps 134, 136 have been mechanically decoupled, the passenger section 108 (FIG. 1) being replaced can be structurally separated from its adjacent sections 106, 110 (FIG. 1). Accordingly, the passenger section 108 (FIG. 1) being replaced can be removed from the remaining sections 102, 104, 106, 110 (FIG. 1) of the aircraft fuselage 100 (FIG. 1) via the support 116 of FIG. 3 and replaced with a freighter section via the method 200 of FIG. 2.

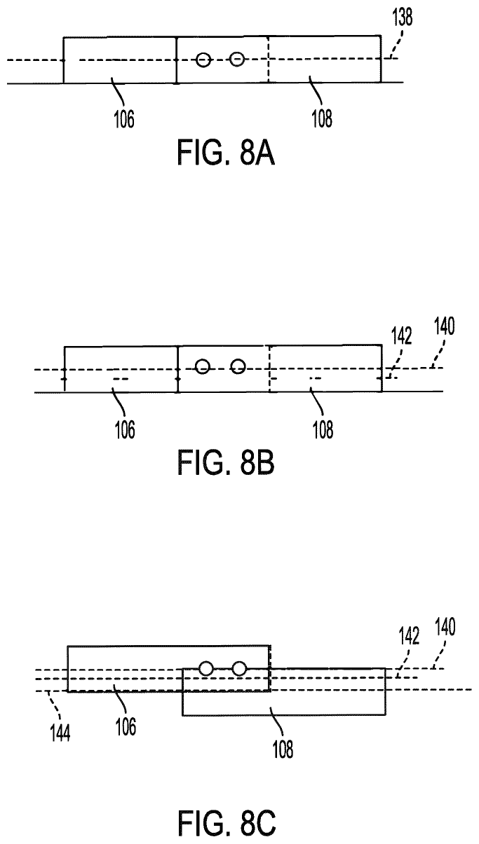

Referring now to FIGS. 8A-C, several mechanical alignments and tolerances between sections 102, 104, 106, 108, 110 of the aircraft fuselage 100 of FIG. 1 are depicted in accordance with at least one non-limiting aspect of the present disclosure. For example, FIG. 8A illustrates a theoretical axis of installation 138 between a passenger section 108 of the aircraft fuselage 100 (FIG. 1) and an adjacent section 106 of the aircraft fuselage 100 (FIG. 1). However, according to the non-limiting aspect of FIG. 8B, a real axis of installation 140 between the passenger section 108 and adjacent section 106 of the aircraft fuselage 100 (FIG. 1) is shown juxtaposed with the theoretical axis of installation 138 of FIG. 8A, illustrating an acceptable level of tolerance. The observable difference between the theoretical axis of installation 138 and the real axis of installation 140 represents the tolerance level. In other words, the real axis of installation 140 is such that the holes between the passenger section 108 and adjacent section 106 of the aircraft fuselage 100 (FIG. 1) are substantially aligned and, more importantly, substantially centered within the respective surfaces of the passenger section 108 and adjacent section 106. However, absent the method 200 (FIG. 2) disclosed herein, when coupled to the adjacent section 106 in lieu of the passenger section 108, a replacement freighter section 109 would have a real axis of installation 142 that represents an unacceptable tolerance level, as is illustrated in FIG. 8C.

Referring now to FIGS. 9A and 9B, a new aircraft 300 that has been converted using the method 200 of FIG. 2 is depicted in accordance with at least one non-limiting aspect of the present disclosure. According to the non-limiting aspect of FIGS. 9A and 9B, the new aircraft fuselage 300 can include a fuselage 301, which includes sections that are substantially configured for passenger transport. For example, according to the non-limiting aspect of FIG. 9, the fuselage 301 can be substantially similar to that of a 72-500. Notably, the fuselage 301 can include a plurality of windows 304 common to aircrafts configured for passenger transport. However, unlike fuselages for passenger transport, the fuselage 301 of FIGS. 9A and 9B can further include a section with a door 302 specifically configured for freighter ingress and egress. According to the non-limiting aspect of FIGS. 9A and 9B, the section of the fuselage 301 that includes such a door 302 can be similar to a corresponding fuselage of a either a 72-212A and/or 72-600 aircraft. As illustrated in FIG. 9A, the fuselage 301 can be specifically configured to accommodate various cargo 306, in spite of the fact that many of its sections are configured for passenger transport.

In further reference to FIGS. 9A and 9B, it becomes evident that the method 200 of FIG. 2 can produce an aircraft 300 with several notable differences from conventional aircrafts configured for passenger and freighter transport. For example, conventional aircrafts configured for freighter transport, such as the either a 72-212A and/or 72-600, generally have a service door defined within a section positioned towards the tail of the fuselage. However, aircrafts that are specifically configured for passenger transport, such as the 72-500, do not have such service doors and thus, neither does the aircraft 300 of FIGS. 9A and 9B.

Additionally, conventional aircrafts configured for freighter transport, such as the either a 72-212A and/or 72-600, do not generally have windows defined throughout the sections of the fuselage. However, aircrafts that are specifically configured for passenger transport, such as the 72-500, do have windows defined throughout the sections of the fuselage and thus, the aircraft 300 of FIGS. 9A and 9B also has windows 304, except for the section that includes the door 302 that is specifically configured for freighter ingress and egress. Moreover, conventional aircrafts configured for freighter transport, such as the either a 72-212A and/or 72-600, generally have other doors with an upper hinge and are configured to swing upwards. However, aircrafts that are specifically configured for passenger transport, such as the 72-500, generally have other doors with a lower hinge that are configured to swing downwards and define stairs to facilitate passenger ingress and egress. Accordingly, the aircraft 300 of FIGS. 9A and 9B also has a downward swinging door 308 that defines stairs, even though the aircraft 300 has been converted via the method 200 of FIG. 2 and is intended for freighter transport.

Accordingly, the aircraft 300 of FIGS. 9A and 9B can be certified for use for freighter transport. For example, the aircraft 300 of FIGS. 9A and 9B can benefit from a supplemental type certificate (“STC”) due to the systematic and structural coupling described in reference to the method 200 of FIG. 2. An STC is a type certificate (“TC”) that issues when an applicant has received governmental approval to modify an aeronautical product from its original design. The STC, which incorporates by reference the related TC, approves not only the modification but also how that modification affects the original design. As such, the aircraft 300 of FIGS. 9A and 9B can be certified for freighter transport, even though the fuselage 301 is substantially configured for passenger transport.

Referring now to FIGS. 10A-E, several coupling devices 400, 402, 404, 406, 408 configured to align neutral axes of fuselage sections and resolve tolerance mismatches are depicted in accordance with at least one non-limiting aspect of the present disclosure. For example, the coupling devices 400, 402, 404, 406, 408 can be configured with particular geometries and mounting configurations such that they can be installed between and align sections (e.g., sections 106, 108, 110) of the fuselage. As noted in reference to the method 200 of FIG. 2, the neutral axes of the passenger aircraft sections (e.g., sections 106, 110) may not align with the neutral axes of the replacement freighter aircraft section (e.g., section 108). Accordingly, mounting hole patterns may be different and misaligned between sections. As such, the coupling devices 400, 402, 404, 406, 408 of FIGS. 10A-E can be configured with varying geometries and mounting hole patterns to ensure that the neutral axes of the passenger aircraft sections (e.g., sections 106, 110) are properly aligned with the neutral axes of the replacement freighter aircraft section (e.g., section 108).

Referring now to FIGS. 11A and 11B, the coupling step 214 of the method of FIG. 2, utilizing the coupling device 408 of FIG. 10E, is depicted in accordance with at least one non-limiting aspect of the present disclosure. According to the non-limiting aspect of FIG. 11A, it becomes apparent that at a particular junction 410 in the fuselage, there is a tolerance mismatch between the mounting holes of section FR34 and section FR33 that is precluding proper and certifiable conversion of the aircraft. Accordingly, the passenger section (e.g., sections 106, 110) cannot be properly aligned with the neutral axes of the replacement freighter aircraft section (e.g., section 108), absent a specifically configured coupling device, such as the device 408 of FIG. 10E. According to FIG. 11B, coupling device 408 has been installed between the sections FR34, FR33 and thus, the neutral axes are aligned and the tolerance mismatches no longer preclude the proper installation of the replacement freighter aircraft section (e.g., section 108).

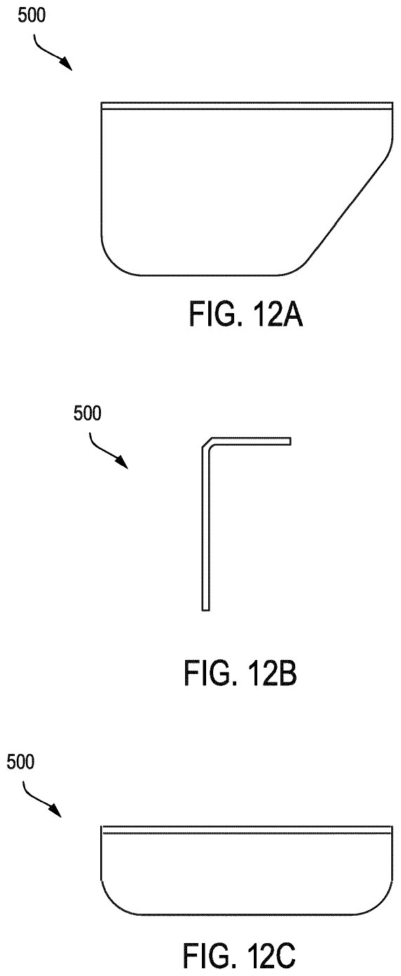

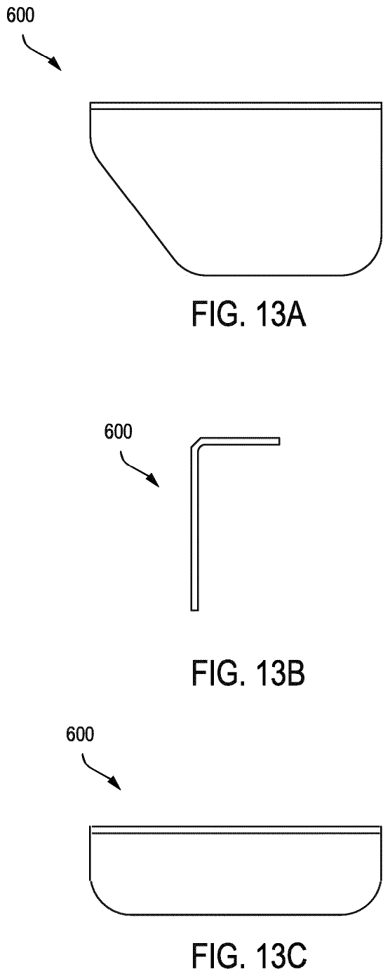

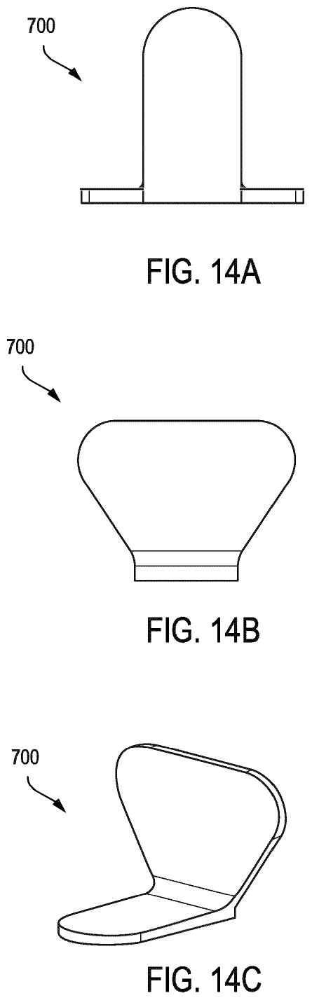

Referring now to FIGS. 12A-C, top, side and front views of another coupling device 500 configured to align neutral axes of fuselage sections and resolve tolerance mismatches are depicted in accordance with at least one non-limiting aspect of the present disclosure. FIGS. 13A-C illustrate a top, side and front view of still another coupling device 600 configured to align neutral axes of fuselage sections and resolve tolerance mismatches, in accordance with at least one non-limiting aspect of the present disclosure. FIGS. 14A-C illustrate a top, front, and isometric view of yet another coupling device configured to align neutral axes of fuselage sections and resolve tolerance mismatches, in accordance with at least one non-limiting aspect of the present disclosure. Similar to the coupling devices 400, 402, 406, 408 of FIGS. 10A-E, the coupling devices 500, 600, 700 can be configured with varying geometries and mounting hole patterns to ensure that the neutral axes of the passenger aircraft sections (e.g., sections 106, 110) are properly aligned with the neutral axes of the replacement freighter aircraft section (e.g., section 108). However, instead of being configured to traverse a longitudinal axis defined by the fuselage of the aircraft, as the coupling devices 400, 402, 404, 406, 408 of FIGS. 10A-E, the coupling devices 500, 600, 700 can be configured to align stringers of a replacement freighter section (e.g., section 108) with the posts of adjacent passenger sections (e.g., sections 106, 110) and vice versa.

Referring now to FIGS. 15A and 15B, the coupling step 214 of the method of FIG. 2, utilizing the coupling device 700 of FIGS. 14A-C, is depicted in accordance with at least one non-limiting aspect of the present disclosure. According to the non-limiting aspect of FIG. 15A, it becomes apparent that at a particular junction 800 in the fuselage, there is a tolerance mismatch between the stringers 804 of a replacement freighter section (e.g., section 108) and the posts 802 of adjacent passenger sections (e.g., sections 106, 110) that is precluding proper and certifiable conversion of the aircraft. Accordingly, the passenger section (e.g., sections 106, 110) cannot be properly aligned with the neutral axes of the replacement freighter aircraft section (e.g., section 108), absent a specifically configured coupling device, such as the device 700 of FIGS. 14A-C. According to FIG. 15B, coupling device 700 has been installed such that the stringer 804 of the replacement freighter section (e.g., section 108) and the post] 802 of the adjacent passenger section (e.g., sections 106, 110) can be secured, thereby aligning the neutral axes and resolving the tolerance mismatch. As such, misalignment no longer precludes the proper installation of the replacement freighter aircraft section (e.g., section 108).

Various aspects of the subject matter described herein are set out in the following numbered clauses:

Clause 1: A method of manufacturing an aircraft that is certifiable for freighter transport, the method including: leveling a first fuselage including a plurality of modular sections, wherein the plurality of modular sections includes a first section, a second section, and an intermediate section, wherein the intermediate section is disposed intermediate the first section and the second section, and wherein leveling the first fuselage offsets loads imposed on the first section, the second section, and the intermediate section; installing a support under the intermediate section of the plurality of modular sections; decoupling a plurality of systems of the intermediate section from a plurality of corresponding systems of the first section and a plurality of corresponding systems of the second section; decoupling a plurality of structural components of the intermediate section from a plurality of corresponding structural components of the first section and a plurality of corresponding structural components of the second section; repositioning the intermediate section such that the intermediate section is no longer disposed intermediate the first section and the second section; positioning a replacement section of a second fuselage such that the replacement section is disposed intermediate the first section and the second section; coupling a plurality of structural components of the replacement section to the plurality of corresponding structural components of the first section and the plurality of corresponding structural components of the second section; coupling a plurality of systems of the replacement section to the plurality of corresponding systems of the first section and the plurality of corresponding systems of the second section; and leveling the replacement section, the first section, and the second section such that loads are imposed on the first section, the second section, and the replacement section.

Clause 2: The method according to clause 1, wherein the first fuselage is that of a passenger aircraft, and wherein the second fuselage is that of a freighter aircraft.

Clause 3: The method according to either of clauses 1 or 2, wherein the passenger aircraft is a 72-500, and wherein the freighter aircraft is a either a 72-212A and/or 72-600.

Clause 4: The method according to any of clauses 1-3, wherein the intermediate section, the first section, and the second section include a first mechanical tolerance, wherein the replacement section includes a second mechanical tolerance, and wherein the first mechanical tolerance is higher than the second mechanical tolerance.

Clause 5: The method according to any of clauses 1-4, further including obtaining a certification from a governmental authority, wherein the certification confirms that the replacement section is acceptable for use with the first fuselage.

Clause 6: The method according to any of clauses 1-5, wherein the support includes at least one castor configured to transport the intermediate section from a first location to a second location; and wherein removing the includes rolling the support away from the first section and the second section.

Clause 7: The method according to any of clauses 1-6,
wherein the plurality of systems of the intermediate section include at least a hydraulic system, an environmental control system, and an electrical system, or combinations thereof.

Clause 8: The method according to any of clauses 1-7, wherein the plurality of structural components of the intermediate section include at least a sheet metal overlay, a skin doubler, and a stringer strap, or combinations thereof.

Clause 9: An aircraft that is certifiable for freighter transport, the aircraft including: a hybrid fuselage including a plurality of modular sections, wherein the plurality of modular sections includes a first section, a second section, and an intermediate section, wherein the intermediate section is disposed intermediate the first section and the second section; a plurality of systems traversing the plurality of modular sections, wherein each system of the plurality comprises portions positioned within each section of the plurality and interfaces configured to systematically couple the portions positioned within each section of the plurality; and a plurality of structural components configured to mechanically couple the intermediate section to the first section and the second section of the plurality of modular sections, wherein the first section and the second section are configured for use with a first fuselage, and wherein the intermediate section is configured for use with a second fuselage.

Clause 10: The aircraft according to Clause 9, wherein the first fuselage is that of a passenger aircraft, and wherein the second fuselage is that of a freighter aircraft.

Clause 11: The aircraft according to either of clauses 9 or 10, wherein the passenger aircraft is a 72-500, and wherein the freighter aircraft is a either a 72-212A and/or 72-600.

Clause 12: The aircraft according to any of clauses 9-11, wherein the first section and the second section include a first mechanical tolerance, wherein the intermediate section includes a second mechanical tolerance, and wherein the first mechanical tolerance is higher than the second mechanical tolerance.

Clause 13: The aircraft according to any of clauses 9-12, wherein the plurality of systems include at least a hydraulic system, an environmental control system, and an electrical system, or combinations thereof.

Clause 14: The aircraft according to any of clauses 9-13, wherein the plurality of structural components of the intermediate section include at least a sheet metal overlay, a skin doubler, and a stringer strap, or combinations thereof.

Clause 15: A system for manufacturing an aircraft that is certifiable for freighter transport, the system including: a first section, a second section, and an intermediate section configured for use with a first fuselage; a replacement section configured for use with a second fuselage, wherein the intermediate section and the replacement section are configured to be disposed intermediate the first section and the second section, wherein the intermediate section and the replacement section are further configured to be mechanically coupled to the first section and the second section via a plurality of structural components, and wherein each of the first section, the second section, the intermediate section, and the replacement section include a portion of a plurality of systems configured to be systematically coupled via a plurality of interfaces; and a support configured to be installed underneath and transport the intermediate section and the replacement section, wherein, when installed underneath the intermediate section and the replacement section, the support is configured to offset loads imposed on the intermediate section and the replacement section.

Clause 16: The system according to clause 15, wherein the first fuselage is that of a passenger aircraft, and wherein the second fuselage is that of a freighter aircraft.

Clause 17: The system according to either of clauses 15 or 16, wherein the passenger aircraft is a 72-500, and wherein the freighter aircraft is a either a 72-212A and/or 72-600.

Clause 18: The system according to any of clauses 15-17, wherein the first section and the second section include a first mechanical tolerance, wherein the intermediate section includes a second mechanical tolerance, and wherein the first mechanical tolerance is higher than the second mechanical tolerance.

Clause 19: The system according to any of clauses 15-18, wherein the plurality of systems include at least a hydraulic system, an environmental control system, and an electrical system, or combinations thereof.

Clause 20: The system according to any of clauses 15-19, wherein the plurality of structural components of the intermediate section include at least a sheet metal overlay, a skin doubler, and a stringer strap, or combinations thereof.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Various exemplary, and illustrative aspects have been described. The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications, or combinations of any of the exemplary aspects may be made without departing from the scope of the claimed subject matter. In addition, persons skilled in the art will recognize, or be able to ascertain using no more than routine experimentation, many equivalents to the various aspects of the present disclosure upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B, and C together, etc.). It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A, and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,”, and the like means that a particular feature, structure, or characteristic described in connection with the aspect is included in at least one aspect. Thus, appearances of the phrases “in one aspect,” “in an aspect,” “in an exemplification,”, and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example, and without limitation, top, bottom, left, right, lower, upper, front, back, and variations thereof, shall relate to the orientation of the elements shown in the accompanying drawing, and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

Any numerical range recited herein includes all sub-ranges subsumed within the recited range. For example, a range of “1 to 100” includes all sub-ranges between (and including) the recited minimum value of 1, and the recited maximum value of 100, that is, having a minimum value equal to or greater than 1, and a maximum value equal to or less than 100. Also, all ranges recited herein are inclusive of the end points of the recited ranges. For example, a range of “1 to 100” includes the end points 1, and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification, and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material, and the existing disclosure material.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The foregoing detailed description has set forth various forms of the devices, and/or processes via the use of block diagrams, flowcharts, and/or examples. Insofar as such block diagrams, flowcharts, and/or examples contain one or more functions, and/or operations, it will be understood by those within the art that each function, and/or operation within such block diagrams, flowcharts, and/or examples can be implemented, individually, and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry, and/or writing the code for the software, and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

1. A method of manufacturing an aircraft that is certifiable for freighter transport, the method comprising:
leveling a first fuselage comprising a plurality of modular sections, wherein the plurality of modular sections comprises a first section, a second section, and an intermediate section, wherein the intermediate section is disposed intermediate the first section and the second section, and wherein leveling the first fuselage offsets loads imposed on the first section, the second section, and the intermediate section;
installing a support under the intermediate section of the plurality of modular sections;
decoupling a plurality of systems of the intermediate section from a plurality of corresponding systems of the first section and a plurality of corresponding systems of the second section;
decoupling a plurality of structural components of the intermediate section from a plurality of corresponding structural components of the first section and a plurality of corresponding structural components of the second section;
repositioning the intermediate section such that the intermediate section is no longer disposed intermediate the first section and the second section;
positioning a replacement section of a second fuselage such that the replacement section is disposed intermediate the first section and the second section;
coupling a plurality of structural components of the replacement section to the plurality of corresponding structural components of the first section and the plurality of corresponding structural components of the second section;
coupling a plurality of systems of the replacement section to the plurality of corresponding systems of the first section and the plurality of corresponding systems of the second section; and
leveling the replacement section, the first section, and the second section such that loads are imposed on the first section, the second section, and the replacement section.

2. The method of claim 1, wherein the first fuselage is that of a passenger aircraft, and wherein the second fuselage is that of a freighter aircraft.

3. The method of claim 2, wherein the passenger aircraft is a 72-500, and wherein the freighter aircraft is a either a 72-212A and/or 72-600.

4. The method of claim 1, wherein the intermediate section, the first section, and the second section comprise a first mechanical tolerance, wherein the replacement section comprises a second mechanical tolerance, and wherein the first mechanical tolerance is higher than the second mechanical tolerance.

5. The method of claim 1, further comprising obtaining a certification from a governmental authority, wherein the certification confirms that the replacement section is acceptable for use with the first fuselage.

6. The method of claim 1, wherein the support comprises at least one castor configured to transport the intermediate section from a first location to a second location; and wherein removing the comprises rolling the support away from the first section and the second section.

7. The method of claim 1, wherein the plurality of systems of the intermediate section comprise at least a hydraulic system, an environmental control system, and an electrical system, or combinations thereof.

8. The method of claim 1, wherein the plurality of structural components of the intermediate section comprise at least a sheet metal overlay, a skin doubler, and a stringer strap, or combinations thereof.

9-14. (canceled)

15. A system for manufacturing an aircraft that is certifiable for freighter transport, the system comprising:
a first section, a second section, and an intermediate section configured for use with a first fuselage;
a replacement section configured for use with a second fuselage, wherein the intermediate section and the replacement section are configured to be disposed intermediate the first section and the second section, wherein the intermediate section and the replacement section are further configured to be mechanically coupled to the first section and the second section via a plurality of structural components, and wherein each of the first section, the second section, the intermediate section, and the replacement section comprise a portion of a plurality of systems configured to be systematically coupled via a plurality of interfaces; and
a support configured to be installed underneath and transport the intermediate section and the replacement section, wherein, when installed underneath the intermediate section and the replacement section, the support is configured to offset loads imposed on the intermediate section and the replacement section

16. The system of claim 15, wherein the first fuselage is that of a passenger aircraft, and wherein the second fuselage is that of a freighter aircraft.

17. The system of claim 16, wherein the passenger aircraft is a 72-500, and wherein the freighter aircraft is a either a 72-212A and/or 72-600.

18. The system of claim 15, wherein the first section and the second section comprise a first mechanical tolerance, wherein the intermediate section comprises a second mechanical tolerance, and wherein the first mechanical tolerance is higher than the second mechanical tolerance.

19. The system of claim 15, wherein the plurality of systems comprise at least a hydraulic system, an environmental control system, and an electrical system, or combinations thereof.

20. The system of claim 15, wherein the plurality of structural components of the intermediate section comprise at least a sheet metal overlay, a skin doubler, and a stringer strap, or combinations thereof.
